(19) United States
(12) Patent Application Publication
(10) Pub. No.: US 2026/0186164 A1
(43) Pub. Date: Jul. 2, 2026

(54) TOOL AND METHOD FOR FAST THREE-DIMENSIONAL MODELLING

(71) Applicant: Schlumberger Technology Corporation, Sugar Land, TX (US)

(72) Inventors: Laurent Mosse, Paris (FR); Jeffrey Miles, Cambridge, MA (US)

(21) Appl. No.: 19/428,731

(22) Filed: Dec. 22, 2025

Related U.S. Application Data
(60) Provisional application No. 63/739,733, filed on Dec. 30, 2024.

(51) Int. Cl. G01V 5/10; G01V 20/00

(52) U.S. Cl. CPC G01V 5/101; G01V 20/00

(57) ABSTRACT

Aspects of the disclosure relate to a method for understanding the response of any multi-detector device to activated oxygen. The method relies on an expression of a three-dimensional distribution of activated oxygen from fast neutron, and on the expression of three-dimensional gamma ray detection efficiency. A realistic model is derived for the signals measured in the detectors as function of the device-to-oxygen differential velocity.

### CROSS-REFERENCE TO RELATED APPLICATIONS

The present application claims priority to U.S. Provisional Application 63/739,733 dated Dec. 30, 2024, the entirety of which is incorporated by reference.

### FIELD OF THE DISCLOSURE

Aspects of the disclosure relate to three-dimensional modeling. More specifically, aspects of the disclosure relate to determining an elemental composition of a subterranean geological formation using three-dimensional modelling and downhole tools.

### BACKGROUND

Using nuclear downhole tools, the elemental composition of a subterranean formation may be determined in a variety of ways. An indirect determination of formation lithology may be obtained using information from density and photoelectric effect (PEF) measurements from gamma-ray scattering in the formation. A direct detection of formation elements may be obtained by detecting neutron-induced gamma-rays. Neutron-induced gamma-rays may be created when a neutron source within a downhole tool emits neutrons into a formation. The emitted neutrons then interact with formation elements through inelastic scattering, high-energy nuclear reactions, or neutron capture.

As a result of inelastic or capture reactions, certain formation based nuclei may become radioactive during such downhole activities. Each radioactive isotope identified in the formation may have a characteristic half-life as well as a characteristic decay path to a non-radioactive element. The decay of most radioactive elements may be accompanied by the emission of one or more characteristic gamma-rays. These characteristic gamma-rays may be sensed and then used to identify the element of the formation that is decaying. As a result, such analysis may indicate a unique formation element that has been activated by inelastic scattering or neutron capture.

Various formation measurements may be obtained based on the above-described nuclear reactions. For example, fracture height determination in a formation may be performed by injecting radioactive tracer elements into the formation with fracture fluid and proppant and then subsequently measuring characteristic gamma-rays emitted by the tracer elements. The use of a radioactive tracer; however, may introduce a number of regulatory, environmental, and other challenges, as the radioactive tracer may be in liquid form and thus easily dispersible. As such, certain techniques have been developed to avoid the use of radioactive tracer in fracture height determination. These techniques may involve the injection of an inert liquid tracer into the formation, which may be subsequently bombarded with neutron radiation to activate the tracer in the liquid. In carrying out these techniques; however, the source of the activating neutron radiation may be moved away from the point of measurement, and the activation radiation may be measured at a later time when a gamma-ray detector or other detector passes by this point. In certain cases, the intervening time between activation and measurement may allow materials in the tracer-containing fracture fluid to move, which may result in an incorrect interpretation of a formation fracture or other formation properties.

Using oxygen activation of some nuclei to estimate the velocity of water in a wellbore or behind a casing is not a new technique; however, the model used to perform an analysis of the measurement is over simplistic. The actual physics driving the responses in the detectors is not investigated, as well as the influence of tool centricity into hole. The impact of the holdup is not strictly formalized, and the impact of transient conditions is not considered.

There is a need to provide both an apparatus and method to perform detailed three-dimensional modeling that are easier to operate than conventional apparatus and methods.

There is a further need to provide apparatus and methods that do not have the drawbacks discussed above with conventional nuclear wellbore work, such as drift and injection of tracers previously found to be problematic in regulatory circles.

There is a still further need to reduce economic costs associated with operations, apparatus and methods described above with conventional tools.

### SUMMARY

So that the manner in which the above recited features of the present disclosure can be understood in detail, a more particular description of the disclosure, briefly summarized below, may be had by reference to embodiments, some of which are illustrated in the drawings. It is to be noted that the drawings illustrate only typical embodiments of this disclosure and are therefore not to be considered limiting of its scope, for the disclosure may admit to other equally effective embodiments without specific recitation. Accordingly, the following summary provides just a few aspects of the description and should not be used to limit the described embodiments to a single concept.

In one example embodiment, a method to predict a three-dimensional distribution of oxygen in a formation is disclosed. The method may comprise lowering a tool into a formation wellbore. The method may further comprise activating the tool inside the formation, wherein the activating sends neutrons to the formation. The method may further comprise using spectroscopy, measuring a signal amplitude originating from the wellbore resulting from the activating of the tool within at least two different detectors along an axis of the wellbore. The method may further comprise determining an axial velocity of activated oxygen, on a wellbore regional basis, from the measuring of the signal amplitude originating from the activating of the tool.

In another example embodiment, a method to develop continuous oxygen activation response curves for a formation is disclosed. The method may comprise lowering a pulsed neutron lifetime tool into a formation wellbore. The method may further comprise activating the pulsed neutron lifetime tool inside the formation, wherein the activating sends neutrons to the formation, The method may further comprise using spectroscopy, measuring a signal amplitude originating from the wellbore resulting from the activating of the tool within at least two different detectors along an axis of the wellbore, The method may further comprise using a model, performing calculations for continuous oxygen activation responses based upon different positions of the tool within the wellbore to obtain model results. The method may further comprise determining an axial velocity of activated oxygen from the measuring of the signal amplitude originating from the activating of the tool based upon a homogenous medium. The method may further comprise comparing the model results to the determined axial velocity of activated oxygen to determine a closest match producing a final continuous oxygen activation curve.

In another example embodiment, a method to create a water flow log for a formation is disclosed. The method may comprise lowering a tool into a formation wellbore. The method may further comprise activating the tool inside the formation, wherein the activating sends neutrons to the formation. The method may further comprise using spectroscopy, measuring a signal amplitude originating from the wellbore resulting from the activating of the tool within at least two different detectors along an axis of the wellbore. The method may further comprise determining an axial velocity of activated oxygen, on a wellbore regional basis, from the measuring of the signal amplitude originating from the activating of the tool. The method may further comprise correlating the axial velocity of activated oxygen to a flow of water in the formation to produce a water flow log.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the drawings. It is to be noted, however, that the appended drawings illustrate only typical embodiments of this disclosure and are; therefore, not be considered limiting of its scope, for the disclosure may admit to other equally effective embodiments.

FIG. 1 is a series of schematics of source (PNG, P) and detector (R) reponses.

FIG. 2 is a modeled distribution of activated oxygen around the tool, combining a flux of energetic neutrons with the atomic density of oxygen and its cross section for activation. Lines represent an analytical calculation, while black dots show the result of a numerical calculation with code.

FIG. 3 is a schematic for the detector response terms.

FIG. 4 is a schematic of a gamma transport term.

FIG. 5 is a series of schematics of the detection efficiency term.

FIG. 6 is an example of integrated detector efficiency term for a homogeneous medium, and detector of size La.

FIG. 7 is an example of Convolution Kernel for two detectors with different lengths La and at different radial depths in homogeneous medium.

FIG. 8 is an example of continuous oxygen activation for a 3-detector tool (one curve for each detector), as function of differential velocity Δν. The left plot shows the oxygen activation signal on a linear scale, while the right shows the same signals on a log scale.

FIG. 9 is a zoom on homogenous medium COA asymptotic response for a 3-detector tool, as function of differential velocity Δν. Dashed black lines correspond to Δνₓ=ζₓ/τ₀.

FIG. 10 is a zoom on homogenous medium COA asymptotic response for a 3-detector tool, as function of differential velocity Δν. Black lines correspond to functional A/ΔveB/Δv, which does not capture the model complete treatment in this calculation.

FIG. 11 is an example of simple model COA (dashed lines), adjusted to full model (plain lines) at Δν=0.

FIG. 12 is an interpretation of COA curves for the example of a tool logging upward at 10 cm/s. The differential velocity of oxygen-flow versus tool movement is-10 cm/s for non-moving water, more negative for downward flowing water, and more positive for upward flowing water. The differential velocity is greater than zero if the water is flowing upward faster than the tool.

FIG. 13 is an example of 8.5-inch open hole model, with water holdup varying from 0 to 100 percent. In this example embodiment, the tool is centered.

FIG. 14 is an example of 8.5-inch open hole model, normalized to maximum at 1, with water holdup varying from 0 to 100 percent. In this example embodiment, the tool is centered.

FIG. 15 is an example of 8.5-inch open hole model, amplitude at 8 cm/s, as a function of different borehole properties (water holdup at top left, atomic density of oxygen at top right, fluid density at bottom left, and a fast-neutron attenuation factor at bottom right]. All properties are directly correlated with water holdup, in which oxygen-bearing water is substituted for oil in the borehole.

FIG. 16 is a comparison of COA signals from the borehole (left plot) versus formation (right plot), for a tool centered (solid lines) or decentered (dashed lines) in the borehole.

FIG. 17 is an example of an oxygen velocity step profile, corresponding to a water entry in a wellbore. The vertical axis denotes the velocity of the oxygen or tool with respect to depth.

FIG. 18 is an example of COA curves after a step change of oxygen velocity for two different tool speed (log up and log down).

FIG. 19 is a series of examples of variational depths and COA for different log up speeds and fixed differential velocity.

FIG. 20 is a series of examples of variational depths and COA for different log down speeds and fixed oxygen velocity.

FIG. 21 is an example of complex velocity profiles.

FIG. 22 are Tₓ responses for a complex completion case.

FIG. 23 is a series of COA curves for a complex completion case, with casing and tubing, and two step profiles for the oxygen velocities in the tubing and in annulus A.

FIG. 24 is a sketch of water flow log time sequence.

FIG. 25 is an example of water flow log station results for 3 different modes, in open hole.

FIG. 26 is an example of water flow log station results for 3 different modes, in tubing and casing completion.

To facilitate understanding, identical reference numerals have been used, where possible, to designate identical elements that are common to the figures (“FIGS”). It is contemplated that elements disclosed in one embodiment may be beneficially utilized on other embodiments without specific recitation.

### DETAILED DESCRIPTION

In the following, reference is made to embodiments of the disclosure. It should be understood, however, that the disclosure is not limited to specific described embodiments. Instead, any combination of the following features and elements, whether related to different embodiments or not, is contemplated to implement and practice the disclosure. Furthermore, although embodiments of the disclosure may achieve advantages over other possible solutions and/or over the prior art, whether or not a particular advantage is achieved by a given embodiment is not limiting of the disclosure. Thus, the following aspects, features, embodiments and advantages are merely illustrative and are not considered elements or limitations of the claims except where explicitly recited in a claim. Likewise, reference to “the disclosure” shall not be construed as a generalization of inventive subject matter disclosed herein and should not be considered to be an element or limitation of the claims except where explicitly recited in a claim.

Although the terms first, second, third, etc., may be used herein to describe various elements, components, regions, layers, and/or sections, these elements, components, regions, layers, and/or sections should not be limited by these terms. These terms may be only used to distinguish one element, components, region, layer, or section from another region, layer or section. Terms such as “first”, “second”, and other numerical terms, when used herein, do not imply a sequence or order unless clearly indicated by the context. Thus, a first element, component, region, layer, or section discussed herein could be termed a second element, component, region, layer, or section without departing from the teachings of the example embodiments.

When an element or layer is referred to as being “on,” “engaged to”, “connected to”, or “coupled to” another element or layer, it may be directly on, engaged, connected, or coupled to the other element or layer, or interleaving elements or layers may be present. In contrast, when an element is referred to as being “directly on”, “directly engaged to”, “directly connected to”, or “directly coupled to” another element or layer, there may be no interleaving elements or layers present. Other words used to describe the relationship between elements should be interpreted in a like fashion. As used herein, the term “and/or” includes any and all combinations of one or more of the associated listed terms.

Some embodiments will now be described with reference to the figures. Like elements in the various figures will be referenced with like numbers for consistency. In the following description, numerous details are set forth to provide an understanding of various embodiments and/or features. It will be understood, however, by those skilled in the art, that some embodiments may be practiced without many of these details, and that numerous variations or modifications from the described embodiments are possible. As used herein, the terms “above” and “below”, “up” and “down”, “upper” and “lower”, “upwardly” and “downwardly”, and other like terms indicating relative positions above or below a given point are used in this description to more clearly describe certain embodiments.

Aspects of the disclosure relate to a tool and method for activation of some nuclei by fast neutron, such as oxygen-16, and associated spectroscopy to measure a signal originating from the wellbore, the completion, and the formation. From the analysis of the signal amplitude in different detectors located along the axis of the wellbore, within a tool, the axial velocity of activated oxygen can be deduced, and possibly related to different regions of the completion where oxygen can flow (for example in the form of water or carbon dioxide).

Moreover, this type of measurement has application to detect and quantify flow or leakage of water or carbon dioxide in wellbores and completions.

In one embodiment, the method disclosed predicts response of multiple detectors to oxygen activation in a system with a moving tool and flowing water, while accounting for the radial distribution of activated oxygen within different completion regions and the formation.

In one embodiment, the tool system and method also enable a radial interpretation of the measured signal and inference of the flowing water velocity. The flowing oxygen may occur in water or carbon dioxide.

In one embodiment, a new three-dimension formalism is formulated to understand the response of any multi-detector pulse neutron logging (PNL) device to activated oxygen. By using this formalism, one can derive a realistic model for the signals measure in the detector as function of the device-to-oxygen differential velocity in different part of the completion and formation. The formalism can be used to interpret both water flow log stations, and continuous oxygen activation measurements.

### Three-Dimensional Formalism for Oxygen Activation

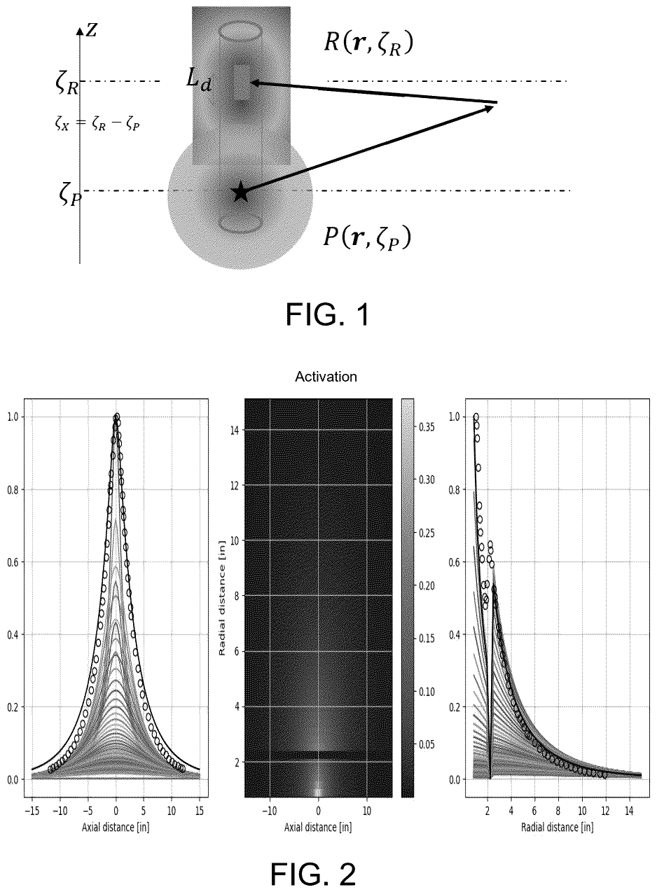

The geometry and axis are defined in FIG. 1. Zeta ζ represents the index along tool/wellbore axis. The coordinate used are usually cylindrical, and r=(ρ, θ, z) and s=(ρ, θ) is written, i.e. the coordinates in the plane perpendicular to the well axis. For sake of simplicity, the tool center is located on the origin of the frame. The detector axial positions relative to the PNG source are denoted ζₓ, and the axial lengths are denoted L_{d}, as shown in FIG. 1.

The distribution of activated oxygen around the neutron source is defined as P(r,ζ_{P}). The 3D distribution P(r,ζ_{P}) depends on the details of the completion and formation, and on the type of fluid in tubing, and annuli, if any. While one can assume translational invariance along z for the formation and completion, varying holdup will break this invariance.

It is assumed that holdup variations are smooth as compared to the transient length of the measurement and that the variations maintain the assumption axial invariance of P(r,ζ_{P}). This leads to the simplification:

$$( r , {ζ}_{P} ) = P ( ρ , ϕ , \vert z - {ζ}_{P} \vert ) \qquad ( 1 )$$

wherein the receiver response is called R(r,ζ_{R}). Following the same assumptions as for the source activation term, the equation can be written as:

$$R ( r , {ζ}_{R} ) = R ( ρ , ϕ , \vert z - {ζ}_{R} \vert ) . \qquad ( 2 )$$

Tool velocity is a scalar ν_{T}(ζₚ, t) value that depends on tool position at a given time and oxygen velocity is scalar field ν_{O}(r, t) that depends on both position and time. By definition, velocities are positive when going uphole. It may be also assumed that during the time of the measurement, conditions are static.

The source burst scheme is defined by the value B(t), which is the instantaneous burst intensity in unit [1/time]. Considering the time scale involved in the Burst description and the oxygen decay time, the time or space dependency of B may be ignored and replaced by a simple duty cycle.

### Counts in Detectors

As an example, the logging is started at time t₀ with no previous activation. The spatial distribution A(r, t) of activated oxygen is formalized at time t. As this formalism can be also used for OA time stations, one will explicitly keep track of the burst timing term B. At initial time t₀, the source is located at elevation ζ₀ and one have over an infinitesimal time step dτ

$$A ( r , {t}_{0} ) = P ( r , {ζ}_{0} ) B ( {t}_{0} ) d τ .$$

At the end of this step dτ, the original activated signal has been shifted by νₒ(r,t₀)dτ and reduced by

$${e}^{- \frac{d τ}{{τ}_{0}}} .$$

Simultaneously, a new fresh activation signal is emitted by the source at location ζ₀+ν_{T}(t₀)dτ. This results in:

$$A ( r , {t}_{0} + d τ ) = P ( r , {ζ}_{0} + {v}_{o} ( s , {ζ}_{0} , {t}_{0} ) d τ ) B ( {t}_{0} ) d τ {e}^{- \frac{d τ}{{τ}_{0}}} + P ( r , {ζ}_{0} + {v}_{T} ( {ζ}_{0} , {t}_{0} ) d τ ) \cdot B ( {t}_{0} + d τ ) d τ$$

which is iterate and written (omit the r parameter on P for simplicity) as:

$$A ( r , {t}_{0} + 2 d τ ) = P ( {ζ}_{0} + {v}_{o} ( s , {ζ}_{0} , {t}_{0} ) d τ + {v}_{o} ( s , {ζ}_{0} + {v}_{o} ( s , {ζ}_{0} , {t}_{0} ) d τ , {t}_{0} + d τ ) d τ ) \cdot B ( {t}_{0} ) d τ \cdot {e}^{- \frac{2 d τ}{{τ}_{0}}} + P ( {ζ}_{0} + {v}_{T} ( {ζ}_{0} , {t}_{0} ) d τ + {v}_{o} ( s , {ζ}_{0} + {v}_{o} ( s , {ζ}_{0} , {t}_{0} ) d τ , {t}_{0} + d τ ) d τ ) \cdot B ( {t}_{0} + d τ ) d τ {e}^{- \frac{d τ}{{τ}_{0}}} + P ( {ζ}_{0} + {v}_{T} ( {ζ}_{0} , {t}_{0} ) d τ + {v}_{T} ( {ζ}_{0} + {v}_{T} ( {ζ}_{0} , {t}_{0} ) d τ , {t}_{0} + d τ ) d τ ) \cdot B ( {t}_{0} + 2 d τ ) d τ .$$

The ordinates ζ_{k,n} that follows the recurrence equations are defined as:

$${ζ}_{k , j + 1} ( s ) = \{ \begin{matrix}{ζ}_{k , j} + {v}_{T} ( s , {ζ}_{k , j} , {t}_{0} + jd τ ) d τ & if j + 1 < k \\ {ζ}_{k , j} + {v}_{o} ( s , {ζ}_{k , j} , {t}_{0} + jd τ ) d τ & if j + 1 \geq k\end{matrix} \qquad ( 3 )$$

with ζ_{0,0}=ζ₀. ζ_{k,n} that provides the location at any time ndt of the oxygen that was activated at time kdt. It depends on radial location s, as oxygen velocity may depend on radial location. This signal is damped by the factor

$${e}^{- k \frac{d τ}{{τ}_{0}}} . {ζ}_{n , n}$$

is the source location at time ndt.

Next, A(r, t₀+2dτ) is reformulated as:

$$A ( r , {t}_{0} + 2 d τ ) = P ( r , {ζ}_{0 , 2} ( s ) ) B ( {t}_{0} ) d τ {e}^{- \frac{2 d τ}{{τ}_{0}}} + P ( r , {ζ}_{1 , 2} ( s ) ) B ( {t}_{0} + d τ ) d τ {e}^{- \frac{d τ}{{τ}_{0}}} + P ( r , {ζ}_{2 , 2} ( s ) ) B ( {t}_{0} + 2 d τ ) d τ .$$

At any discretized time, the following equation may be written where k represents an index backward in time

$$A ( r , {t}_{0} + n d τ ) = {\sum }_{k = 0}^{n} P ( r , {ζ}_{n - k , n} ( s ) ) B ( {t}_{0} + ( n - k ) d τ ) d τ {e}^{- k \frac{d τ}{{τ}_{0}}} . \qquad ( 4 )$$

Or having k as an index forward of time (k=0 is at time t₀)

$$A ( r , {t}_{0} + n d τ ) = {\sum }_{k = 0}^{n} P ( r , {ζ}_{k , n} ( s ) ) B ( {t}_{0} + k d τ ) d τ {e}^{- ( n - k ) \frac{d τ}{{τ}_{0}}} . \qquad ( 5 )$$

While expressing the dynamic ordinates is tractable through recurrence relations, it is not easy to transform the latter into simple integral form. Only in simple situations is it possible to simplify the equations (2) and (3).

The counts measured into a detector may be evaluated at any time t₀+ndτ, located at ζ_{n,n}+ζ_{X}. The tool elevation ζ_{n,n} is independent of s as it only depends on tool speed.

$${C}_{X} ( {t}_{0} + n d τ ) = \int \int \int dr A ( r , {t}_{0} + nd τ ) \cdot {R}_{X} ( r , {ζ}_{n , n} + {ζ}_{X} ) = \int \int \int dr {\sum }_{k = 0}^{n} P ( r , {ζ}_{k , n} ( s ) ) B ( {t}_{0} + kd τ ) d {τe}^{- ( n - k ) \frac{d τ}{{τ}_{0}}} \cdot {R}_{X} ( r , {ζ}_{n , n} + {ζ}_{X} ) = {\sum }_{k = 0}^{n} [ \int \int \int drP ( r , {ζ}_{k , n} ( s ) ) {R}_{X} ( r , {ζ}_{n , n} + {ζ}_{X} ) ] B ( {t}_{0} + k d τ ) d τ {e}^{- ( n - k ) \frac{d τ}{{τ}_{0}}}$$

It is convenient to define the fully integrated convolution kernel

$${T}_{X} ( k , n ) = \int \int \int dr P ( r , {ζ}_{k , n} ( s ) ) {R}_{X} ( r , {ζ}_{n , n} + {ζ}_{X} ) \qquad ( 6 )$$

and the partially integrated convolution kernel

$${K}_{X} ( s , n , k ) = {\int }_{- ∞}^{+ ∞} d z P ( r , {ζ}_{k , n} ( s ) ) {R}_{X} ( r , {ζ}_{n , n} + {ζ}_{X} ) .$$

The axial invariance of both P and R is leveraged and make a change of variable in the z integral

$${K}_{X} ( s , n , k ) = {\int }_{- ∞}^{+ ∞} d z P ( r , {ζ}_{k , n} ( s ) - {ζ}_{n , n} - {ζ}_{X} ) {R}_{X} ( r , 0 ) . \qquad ( 7 )$$

Next, generically define

$${K}_{X} ( u , s ) = {\int }_{- ∞}^{+ ∞} d z P ( z , s , u ) {R}_{X} ( r , 0 ) \qquad ( 8 )$$

that represents the convolution kernel for an elevation argument u, at radial location s. K_{X}(u, s) is maximum for u=0 and symmetric in u:K_{X}(−u, s)=K_{X}(u, s). Followed by further simplifying with

$${K}_{X} ( u , s ) = {\int }_{0}^{+ ∞} d z [ P ( s , \vert z - u \vert ) + P ( s , \vert z + u \vert ) ] {R}_{X} ( s , \vert z \vert ) . \qquad ( 9 )$$

$$Finally$$

$${C}_{X} ( {t}_{0} + n d τ ) = {\sum }_{k = 0}^{n} {T}_{X} ( n , k ) \cdot B ( {t}_{0} + k d τ ) d τ {e}^{- ( n - k ) \frac{d τ}{{τ}_{0}}} .$$

### Special Case of Invariant Velocities in the Axial Direction

If velocities are invariant in the axial direction, then, simplifying equation (7). reduces to:

$${ζ}_{k , n} ( s ) = {ζ}_{0} + {\sum }_{j = 0}^{k - 1} {v}_{T} ( s , {t}_{0} + j d τ ) + {\sum }_{j = k}^{n - 1} {v}_{0} ( s , {t}_{0} + jd τ ) . \qquad ( 10 )$$

This expression may be transformed into a continuous integral form with t←ndτ and τ←kdτ, and

$$ζ ( s , t , τ ) = {ζ}_{0} + {\int }_{o}^{τ} d ξ {v}_{T} ( {t}_{0} + ξ ) + {\int }_{τ}^{t} d ξ {v}_{o} ( s , {t}_{0} + ξ ) , \qquad ( 11 )$$

and the expression for K becomes

$${K}_{X} ( s , t , τ ) = {\int }_{- ∞}^{+ ∞} d z P ( r , {\int }_{τ}^{t} d ξ {v}_{o} ( s , {t}_{0} + ξ ) - {\int }_{τ}^{t} d ξ {v}_{T} ( {t}_{0} + ξ ) - {ζ}_{X} ) {R}_{X} ( r , 0 ) . \qquad ( 12 )$$

It follows that the equation (8) becomes

$${C}_{X} ( {t}_{0} + t ) = {\int }_{0}^{t} d τ \int \int ds {K}_{X} ( s , t , τ ) B ( {t}_{0} + τ ) {e}^{- \frac{t - τ}{{τ}_{0}}} . \qquad ( 13 )$$

$$Or equivalently :$$

$${C}_{X} ( {t}_{0} + t ) = {\int }_{0}^{t} d τ \int \int ds {K}_{X} ( s , t , t - τ ) B ( {t}_{0} + t - τ ) {e}^{- \frac{τ}{{τ}_{0}}} . \qquad ( 14 )$$

Note that if the activation term alone is reverted back to, then it reads:

$$A ( r , {t}_{0} + t ) = {\int }_{0}^{t} d τ B ( {t}_{0} + t - τ ) P ( r , {ζ}_{0} + {\int }_{t - τ}^{t} d ξ {v}_{o} ( s , {t}_{0} + ξ ) + {\int }_{o}^{t - τ} d ξ {v}_{T} ( {t}_{0} + ζ ) ) {e}^{- \frac{τ}{{τ}_{0}}} \qquad ( 15 )$$

and the generalization of the source term of equation (4) is recognized.

### Definition of Source Term P

As taught above, a component of the OA computation is the convolution term K_{X}:

$${K}_{X} ( u , s ) = {\int }_{- ∞}^{+ ∞} d z P ( z , s , u ) {R}_{X} ( r , 0 ) .$$

Oxygen is activated by high energy neutrons. To understand the distribution of activated oxygen, the amount of high energy neutrons may be estimated at a given distance from the source, using a simplified formalism based on the slowing down length Lₛ, as shown in equation (16), representing the flux of epithermal neutrons at a distance r for the source.

$${Φ}_{N} ( r ) ∝ Q \frac{{e}^{- \frac{r \sqrt{2}}{{L}_{s}}}}{4 π r {D}_{1}} \qquad ( 16 )$$

The source as a point source is approximated, so that P may be approximated with

$$P ( r , 0 ) ∝ Q \frac{{e}^{- \frac{r \sqrt{2}}{{L}_{s}}}}{4 π r {D}_{1}} {n}_{o} ( r ) \qquad ( 17 )$$

where n_{O}(r) is the oxygen density distribution around the tool. Table 1 presents characteristic lengths (including slowing-down and diffusion lengths) of typical materials found in completions and formations.

The slowing-down length Ls represents the RMS distance traveled by a fast neutron (here starting at 14.1 MeV) from its point of creation until its energy is reduced to an epithermal energy threshold (around 0.4 eV). The diffusion length Ld represents the RMS distance traveled by a thermal neutron before its absorption, and the migration length Lm is the quadrature sum of Ls and Ld.

TABLE 1
Characteristic lengths for neutron transport
at 14.1 MeV, with associated properties.

| Material | HI [v/v] | DEN [g/cc] | Ls [cm] | Ld [cm] | Lm [cm] |
|---|---|---|---|---|---|
| Fresh water | 1.002 | 1.0 | 12.71 | 2.75 | 13.03 |
| 250ppk | 0.892 | 1.19 | 12.68 | 1.20 | 12.77 |
| water | | | | | |
| 1.0 CH4 + | 2.193 | 1.0 | 7.48 | 1.26 | 7.59 |
| 1% O | | | | | |
| 0.75 | 1.645 | 0.75 | 9.97 | 1.69 | 10.13 |
| 0.5 CH4 | 1.097 | 0.5 | 14.96 | 2.53 | 15.19 |
| 50-50 1.0 | 1.598 | 1.0 | 9.37 | 1.73 | 9.54 |
| 50-50 0.75 | 1.323 | 0.875 | 11.11 | 2.09 | 11.33 |
| 50-50 0.5 | 1.049 | 0.75 | 13.66 | 2.64 | 13.94 |
| Cement | | 2 | 14.00 | 6.33 | 15.58 |
| Casing | | 7.97 | 25.85 | 1.18 | 25.93 |

For a complex completion, the distribution of activated oxygen is computed in 3D, accounting for possible eccentricity. The flux of high energy neutrons is computed at each position, accounting for all the material that is crossed in a straight line from the source to that point. At each position, the high-energy neutron flux is multiplied by the atomic density of oxygen at that location and its cross section for activation. The relevant cross section for the O16(n,p) oxygen activation reaction may be taken to be approximately 45 mb for analytical estimates.

An example of activated oxygen distribution is given in FIG. 2, for a tool centered in a 5.5-in casing. The black dots are the results of the corresponding MCNP simulation.

### Definition of Detector Term R

The computation of the detector term is more complex that the computation of the source term because the finite detector size may need to be accounted for. Ray tracing and volume crossing computation may be used from any point around the tool to compute the detector response. A simple approach using only solid angle computation to detector face was revealed to not be accurate enough to reproduce simulations.

The detector response is decomposed into 2 terms:
1. GT: the gamma transport term, representing the efficiency (probability of survival) of gamma rays traveling from a point of emission to the surface of the detector face.
2. DE: the detection efficiency term, accounting for the path length of the gamma ray as it traverses the detector, and the resulting efficiency of detection (i.e. the probability of depositing energy above a detection threshold) within the detector.

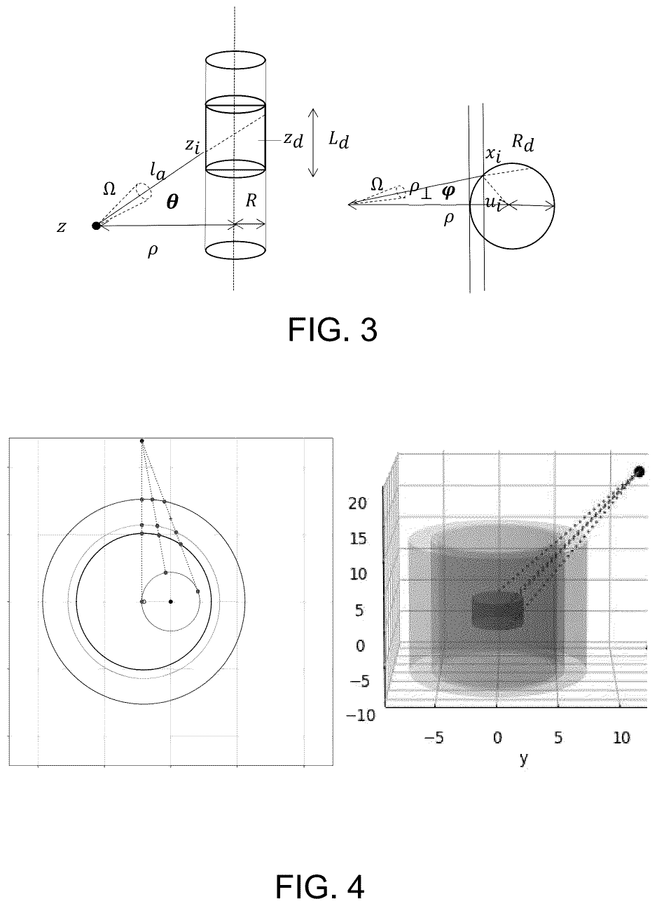

A formulation is given in equation (18), and the schematic of detection response is given in FIG. 3. A simple solid angle computation, using known formula expressing solid angles in suspended rectangular slot was tested, but does not provide the same level of accuracy and possibility of coupling with detector response as the DE term below.

$${R}_{X} ( ρ , ϕ , z ) = \frac{1}{4 π} {\int }_{0}^{2 π} d θ {\int }_{0}^{2 π} d φ {GT}_{X} ( ρ , θ , φ ) \cdot {DE}_{X} ( ρ , θ , φ ) . \qquad ( 18 )$$

The gamma transport term is simplified as shown in equation (19):

$$T ( ρ , θ , φ ) = {\prod }_{layers} {e}^{- {( \frac{μ}{ρ} )}_{H 2 O} {ρ}_{b} ( ρ , φ ) \cdot dl} \qquad ( 19 )$$

$$where {( \frac{μ}{ρ} )}_{H 2 O}$$

is the mass-attenuation coefficient (total scattering cross section per unit mass of a material, normalized by water), ρ_{b}(ρ,φ) is the density of the point (ρ,φ) and dl is the distance crossed in a given layer. The selected mass-attenuation coefficient includes the effects of Compton scattering and photoelectric absorption for gamma rays at 6.13 MeV, the characteristic energy of gamma rays emitted by oxygen activation decay.

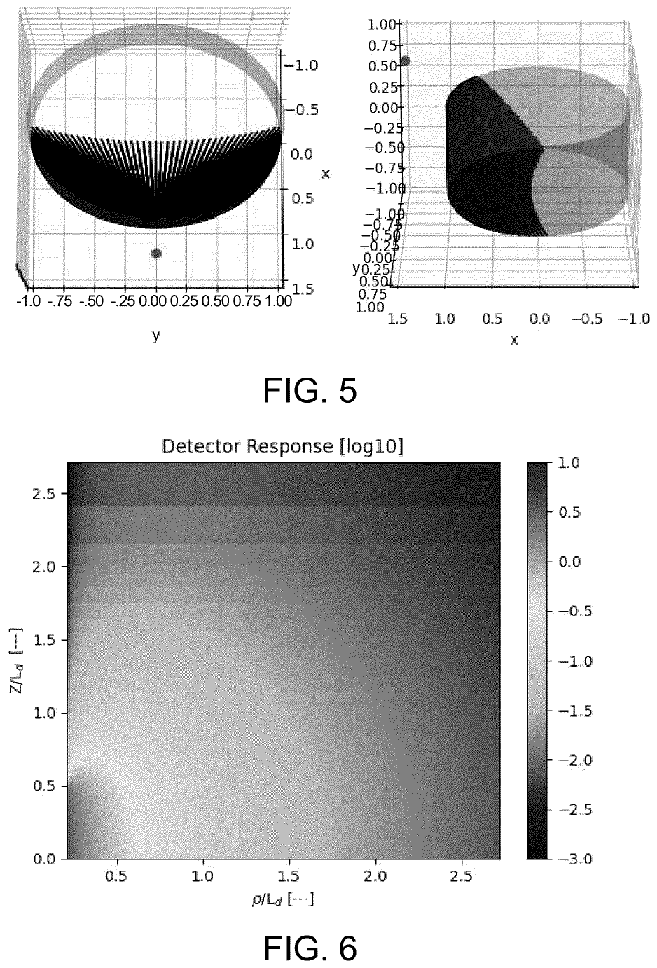

The detector efficiency term can be simplified as shown in equation (20):

$${DE}_{X} ( ρ , θ , φ ) = 1 - {e}^{- {μ}_{d} {R}_{d} ( ρ , θ , φ )} , \qquad ( 20 )$$

where μ_{d} is the reduced Compton cross section per length of the detector material, and R_{d}(ρ,θ,φ) is the crossing length within the detector. Schematics of the detection efficiency term are represented in FIG. 5.

FIG. 6 shows an example of detector response in a homogeneous medium, for a detector of size L_{d}.

### EXAMPLES OF APPLICATION

### Example of Application 1: Homogeneous Medium, Constant Velocities, Radially Uniform

In homogenous medium with constant velocity (no time dependency) and radially uniform (no dependency on s), the expression of T_{X} can be simplified to

$${T}_{X} ( u ) = \int \int \int drP ( r , u ) {R}_{X} ( r , 0 ) .$$

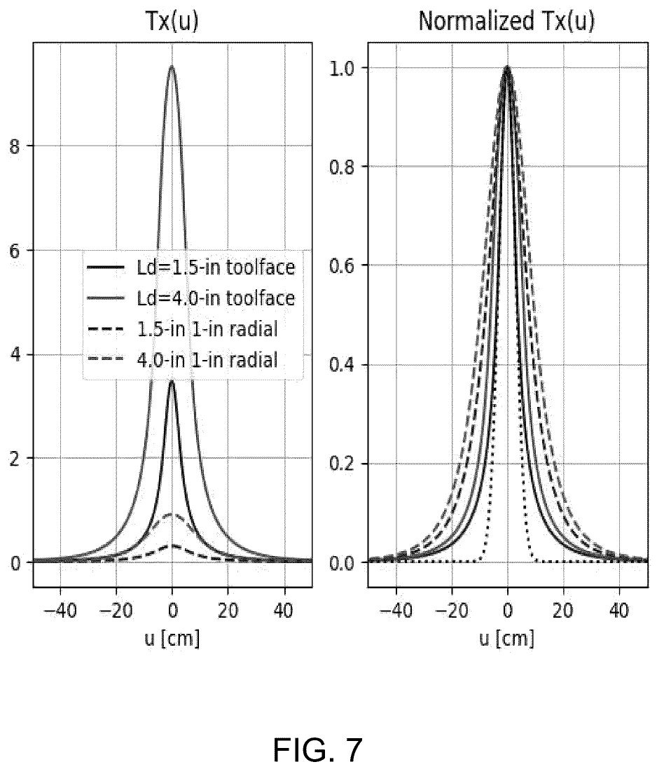

FIG. 7 shows an example of convolution kernel T_{X}(u) for two detectors of different length L_{d} and at two different radial depths ρ: on the tool face, and at 1-inch. It is observed that the longer the detector, the large T_{X} is, as expected. It is also noted that the further away the radial region, the larger is the distribution, also as expected.

A point-like detector and source would provide a bi-exponential kernel, driven by gamma-ray transport. The spatial extent of the detector introduces a solid angle dependency that adds to the biexponential, and the result is difficult to fit with a simple functional. The black dotted line represents an attempt to perform a gaussian fit, which is not a good approximation of T_{X}.

As a first example of application, it may be assumed that the velocities are constant. Δν=ν_{O}−ν_{T} is also noted. Under this assumption, equations (12) reduces to:

$${C}_{X} ( {t}_{0} + t ) = {\int }_{0}^{t} d τ {T}_{X} ( τ Δ v - {ζ}_{X} ) \cdot {e}^{- \frac{τ}{{τ}_{0}}} . \qquad ( 21 )$$

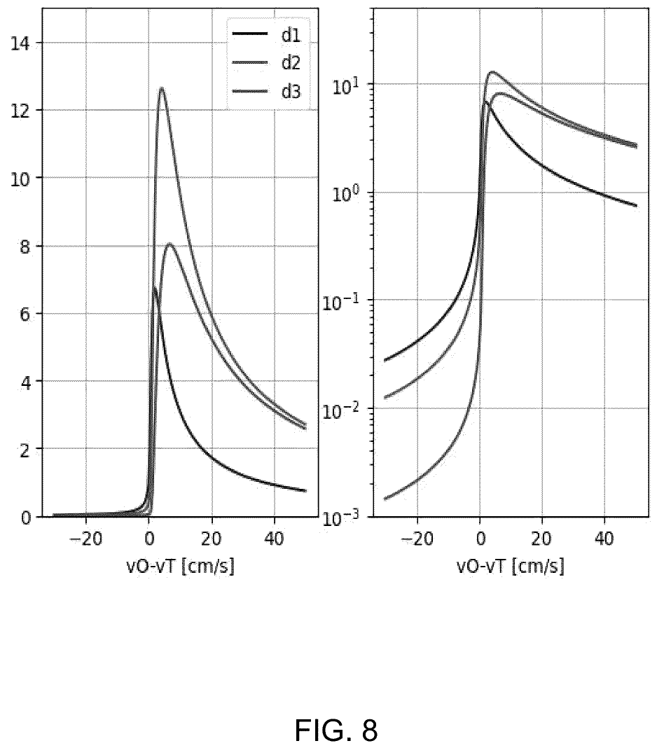

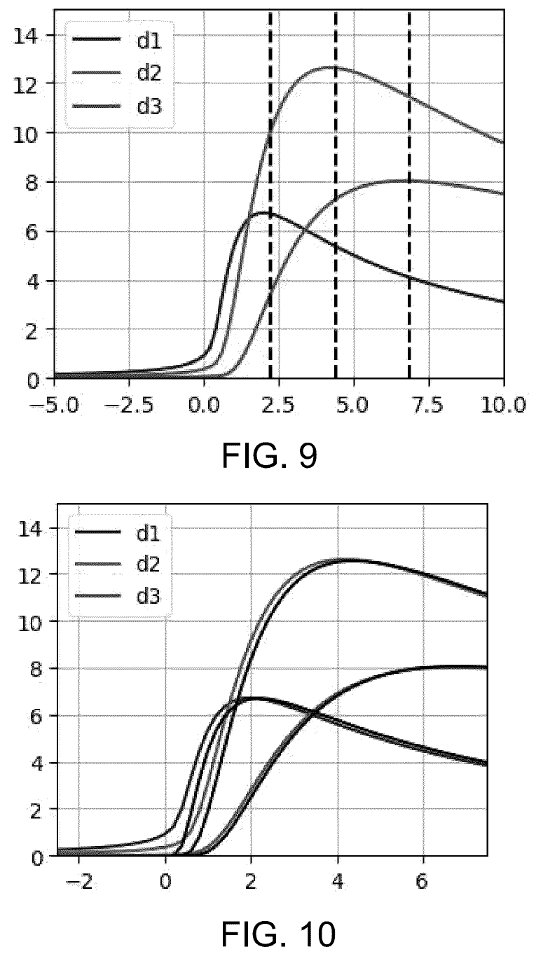

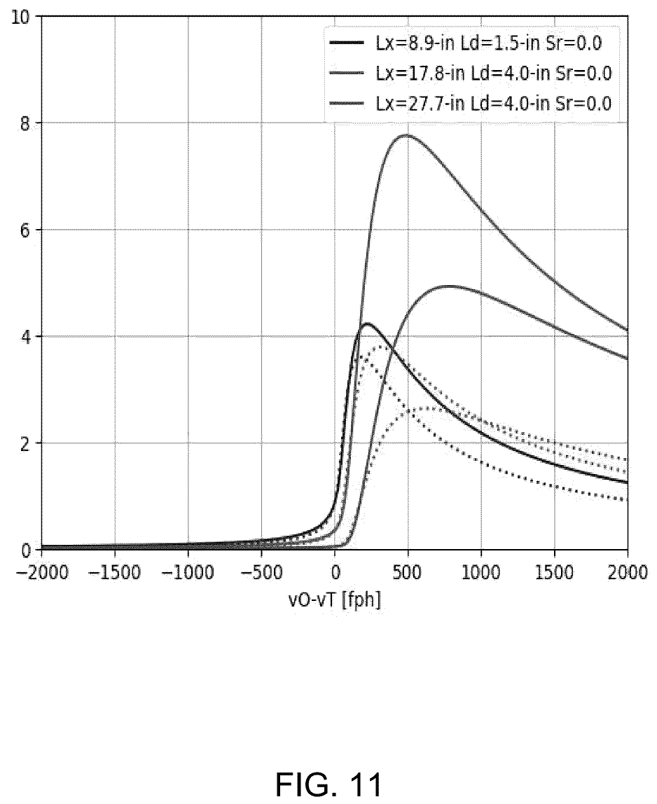

The first illustration is the asymptotic continuous activation, expressed for t→∞, and shown in FIG. 8. A zoom in around the characteristic differential velocities corresponding to ζₓ/τ₀ is shown in FIG. 9. It is also evident that the approximate model equation for

$$COA = \frac{A}{Δ v} {e}^{\frac{B}{Δ v}}$$

cannot reproduce the actual COA, especially at negative differential velocities. An attempt for fitting the actual curves in is shown in FIG. 10.

A less gross approximation of T_{X} is useful to understand the behavior of the COA. For example, write T_{X} may be written as:

$${T}_{X} ( u ) = \{ \begin{matrix}1 & if \vert u \vert < \frac{{L}_{d}}{2} \\ {e}^{- α ( \vert u \vert - \frac{{L}_{d}}{2} )} & if \vert u \vert > \frac{{L}_{d}}{2}\end{matrix} .$$

It comes, for Δν>0

$${C}_{X} ( Δ v ) = {\int }_{0}^{\frac{{ζ}_{X} - \frac{{L}_{d}}{2}}{Δ v}} d τ {e}^{- α ( - Δ v τ + {ζ}_{X} - \frac{{L}_{d}}{2} ) - \frac{τ}{{τ}_{0}}} + {\int }_{\frac{{ζ}_{X} + \frac{{L}_{d}}{2}}{Δ v}}^{∞} d τ {e}^{- α ( Δ v τ - {ζ}_{X} - \frac{{L}_{d}}{2} ) - \frac{τ}{{τ}_{0}}} + {\int }_{\frac{{ζ}_{X} - \frac{{L}_{d}}{2}}{Δ v}}^{\frac{{ζ}_{X} + \frac{{L}_{d}}{2}}{Δ v}} d τ {e}^{- \frac{τ}{{τ}_{0}}} .$$

$$Then$$

$${C}_{X} ( Δ v ) = \frac{{τ}_{0}}{α {τ}_{0} Δ v - 1} ( {e}^{- \frac{{ζ}_{X} - \frac{{L}_{d}}{2}}{Δ v {τ}_{0}}} - {e}^{- α ( {ζ}_{X} - \frac{{L}_{d}}{2} )} ) + \frac{{τ}_{0} {e}^{- \frac{{ζ}_{X} + \frac{{L}_{d}}{2}}{{Δντ}_{0}}}}{α {τ}_{0} Δ v + 1} + {τ}_{0} ( {e}^{- \frac{{ζ}_{X} - \frac{{L}_{d}}{2}}{Δ v {τ}_{0}}} - {e}^{- \frac{{ζ}_{X} + \frac{{L}_{d}}{2}}{{Δντ}_{0}}} ) .$$

It comes, for Δν≤0

$${C}_{X} ( Δ v ) = {\int }_{0}^{∞} d τ {e}^{- α ( - Δ v τ + {ζ}_{X} - \frac{{L}_{d}}{2} ) - \frac{τ}{{τ}_{0}}} = \frac{- {τ}_{0} {e}^{- α ( {ζ}_{X} - \frac{{L}_{d}}{2} )}}{α {τ}_{0} Δ v - 1} .$$

When Δν<0, for example when tool is moving up and when there is no flow, or for the static contribution from the formation, the operand is a strictly decreasing function of Δν and C_{X}(∞, Δν) is monotonically decreasing as

$$\frac{1}{a {τ}_{0} Δ v - 1} ,$$

which is a behavior closer to full model and reality. It is possible to match the Δν<0 parts of the distributions, for example by adjusting α so that curves match at 0, but it is not possible in this case to match correctly the amplitudes for Δν>0.

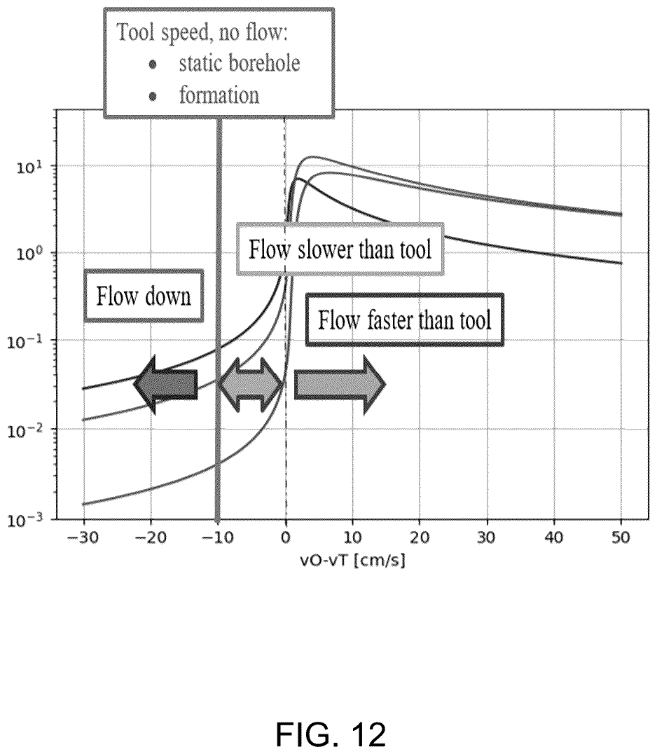

In summary, while it is possible to infer the general behavior of the COA curves by simple generalization of T_{X}(u), the accurate description of their patterns requires the dedicated 3D modeling. The typical interpretation of these curves in the context of COA is shown in FIG. 12.

### Example of Application 2: Open Hole, Invariant Velocities but Radially Uniform, Tool Centered or Decentered

For this second example, an 8.5-inch borehole is modeled, surrounded by a 20 pu water-filled limestone. The water hold-up in the borehole is varied from 0 to 100 percent. In a first model, a 1 11/16-inch diameter, 3-detector tool is centered in the borehole. The tool itself is axisymmetric. In a second model, the tool is fully decentralized and pressed against the formation.

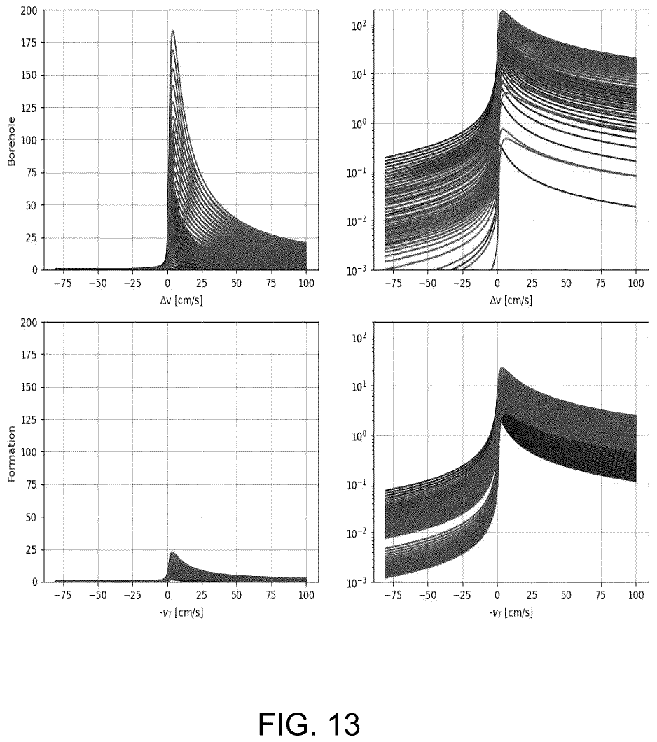

FIG. 13 shows the results of the centered model COA curves. Colors for each detector are the same as for previous figures. Several curves for the same detector are plotted, each corresponding to a different holdup. For the borehole contribution to COA, a strong variation of the amplitude of the signal is observed depending on the water holdup, as expected. The borehole contribution for 100 percent holdup is about 10 times that of the formation. It is important to note that the formation contribution, which will express itself as a constant with values at Δν=−ν_{T} does also vary with borehole holdup. This dependency comes from the fact that neutrons that activate oxygen in the formation must first cross the borehole, and correspondingly, the gamma rays that reach the detectors may scatter in the borehole too.

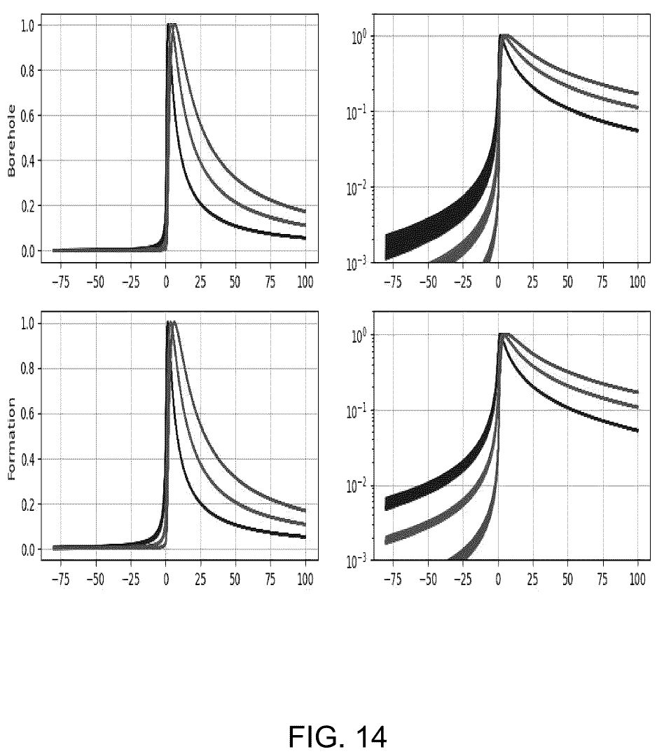

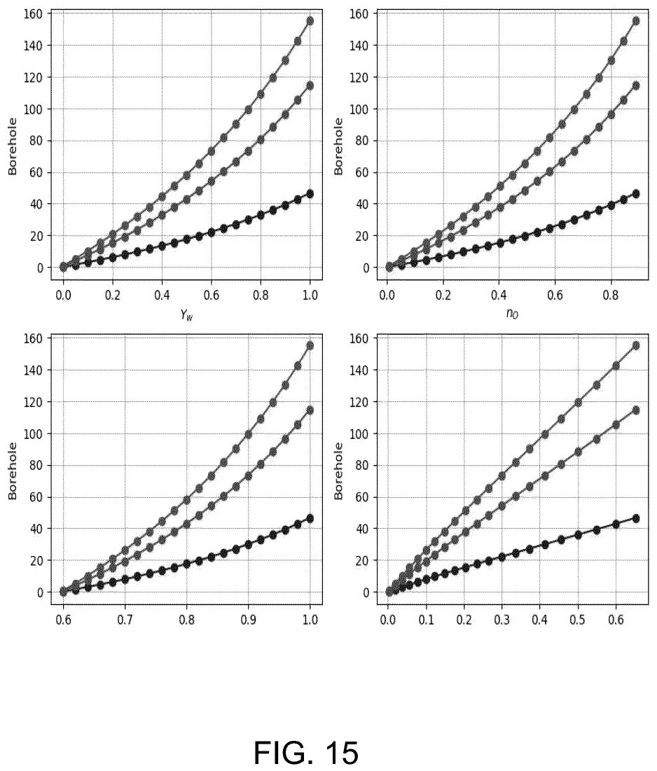

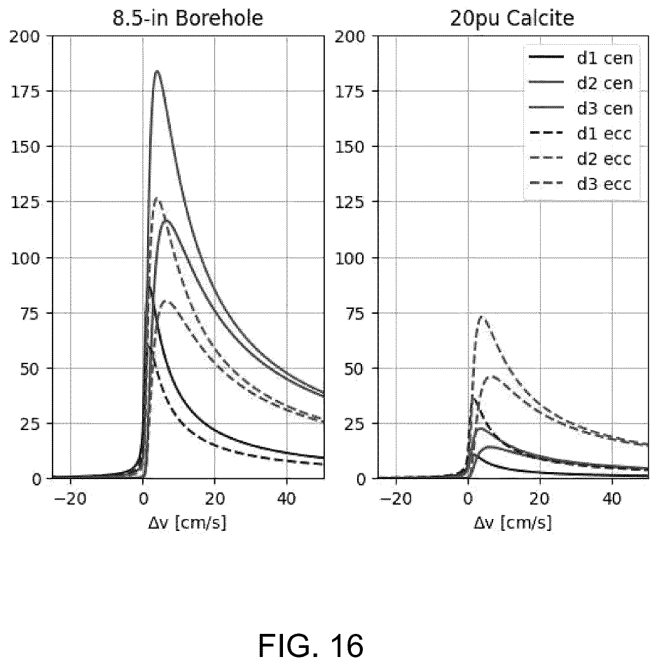

FIG. 14 shows the same results but now normalized to 1.0. Moreover, it is also observed that the shape of the COA curves remains almost unchanged. Only the overall amplitudes change. Moreover, FIG. 14 also illustrates that the dominating factor is associated with the neutron activation process. This is observed from the linearity of the response. Correlation with borehole density is only apparent, as density also correlates with oxygen index in this case.

### Example of Application 3: COA Log Simulation in Open Hole, Tool Decentered, Constant, Radially-Uniform Velocities

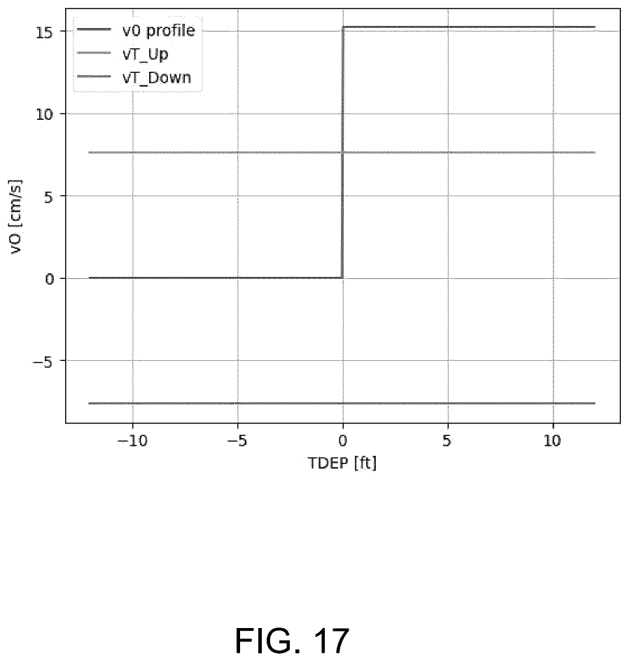

A log simulation is useful to illustrate how the COA curves can be interpreted in realistic conditions. Both a log down and a log up will be simulated in a 8.5-inch open hole, for a 1 11/16-inch, 3-detector decentered tool. Borehole water yield is set to 100 percent. A vertical profile of oxygen velocity is simulated, with static conditions at bottom, followed by a sharp increase of velocity at a certain depth, followed by a slow decrease of this velocity down to a plateau value, as sketched in FIG. 17.

For this simulation, the simplification of invariant velocities cannot be used, and equation (7) and recurrence relation (3) are used instead. ζ_{k,n} represents where the oxygen activated at time kdt is located a time ndt. This signal is damped by the factor

$${e}^{- k \frac{d τ}{{τ}_{0}}} . {ζ}_{n , n}$$

is the source location at time ndt. χ_{k,n}=ζ_{n-k,n}, may also be defined, which represents where the oxygen activated backward with a time step kdt is located a time ndt. It lends itself to an easier representation.

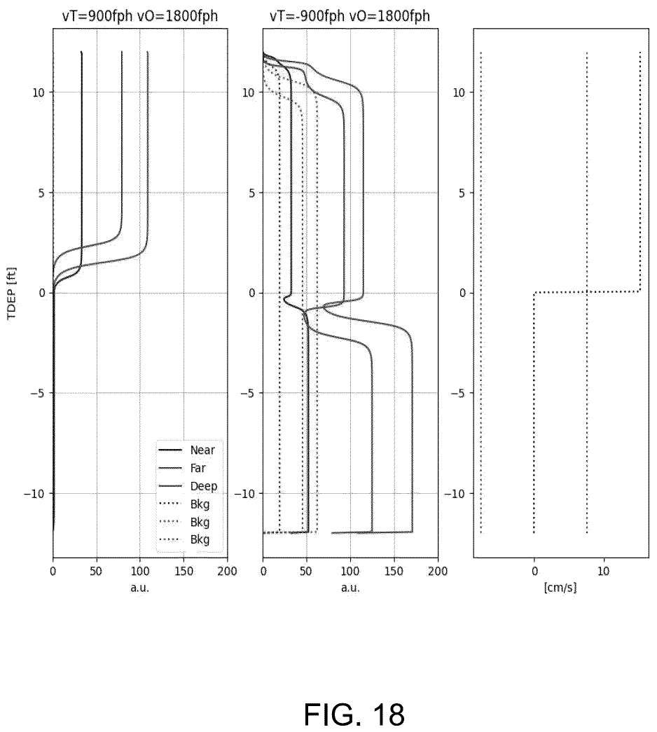

FIG. 18 shows the simulated COA curves for a log up and a log down with Δν=ν_{O}−ν_{T}=900 ft·h⁻¹=7.6 cm·s⁻¹ for the log up.

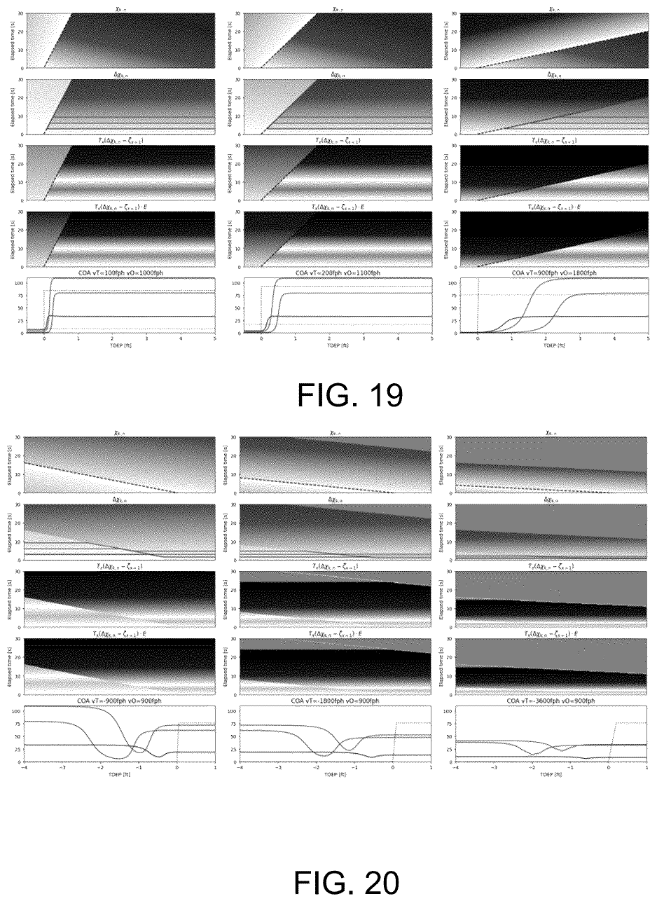

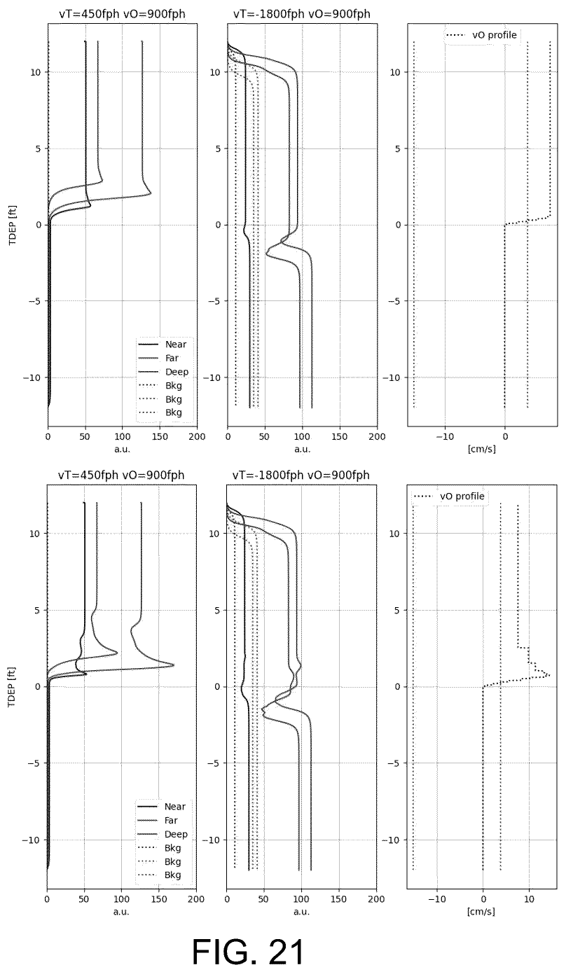

FIG. 19 and FIG. 20 show the χ_{k,n} matrix, the Δχ_{k,n} matrix, the T_{X}(Δχ_{k,n}−ζ_{X}) and the

$${T}_{X} ( Δ {χ}_{k , n} - {ζ}_{X} ) {e}^{- k \frac{d τ}{{τ}_{0}}}$$

terms for x=1. FIG. 19 shows examples of log ups, while and the FIG. 20 shows examples of log down.

In FIG. 19, it is observed that while the patterns at steady state are the same for the COA curves, the transient behavior are different. The distance it needs for the COA to stabilize through

$$Δ z = \frac{{ζ}_{X} {v}_{T}}{{v}_{o} - {v}_{T}}$$

may be expressed.

In FIG. 20, it is observed that the COA patterns vary among different log down speeds; this is because a constant vO is maintained and not constant differential velocity in this example. It is also observed that there is a damp in the COA curves at interface between no flow and flow. This is an expected behavior for log down.

### Example of Application 4: Cased Hole, 8.5-Inch, 7-Inch Casing, 3.5-Inch Tubing. Velocities Constant and Radially-Uniform Per Layer

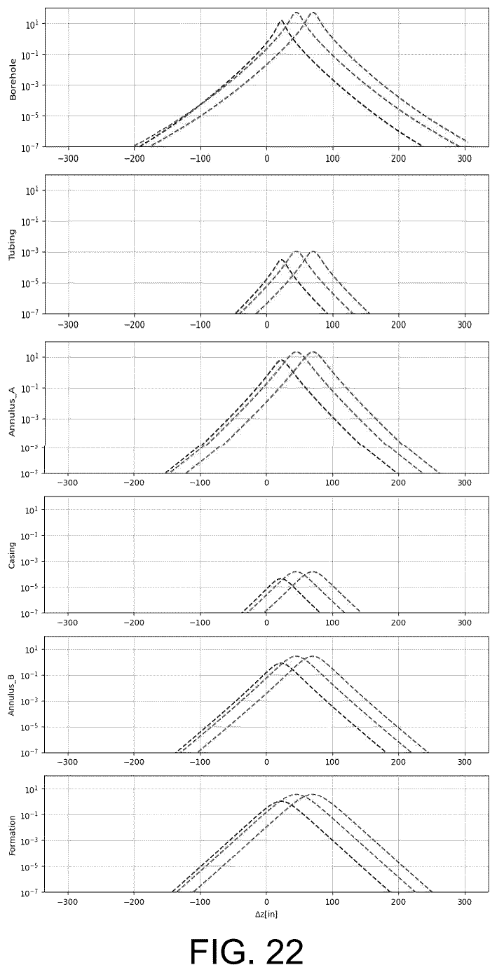

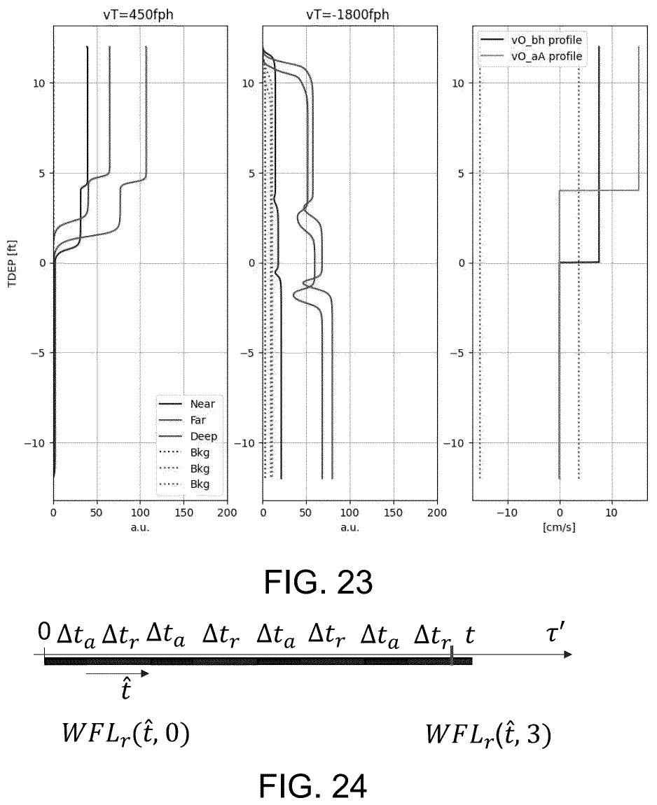

As a last example of application, a complex completion setting is simulated with an 8.5-in hole, completed with a cemented 7-inch casing, and a production 3.5-inch tubing with water in annulus A. FIG. 22 shows the Tₓ responses for the inner tubing (bh) and different completion elements. FIG. 23 shows the results of a log simulation with two step profiles for velocities in the inner tubing and in the annulus A.

### Example of Application 5: Water Flow Station in Open Hole and Cased Hole

Water Flow Logs (WFL) stations are made of repetition of activation/recording sequence, as sketched in FIG. 24. Δtₐ and Δtᵣ are defined as the activation and recording time respectively, and by Δt_{c} the total duration of one sequence. By definition:

$$( τ ) = B for n Δ {t}_{c} < τ < n Δ {t}_{c} + Δ {t}_{a} and 0 otherwise .$$

It is the natural to divide the computation into two parts:
nΔt_{c}<t<nΔt_{c}+Δtₐ: not measured, but useful to understand transient behavior
nΔt_{c}+Δtₐ<t<(n+1)Δt_{c}: measurement time.

The expression for the counting rates in a detector at a time t is derived from equation (11):

$${WFL}_{X} ( {v}_{o} , t ) = {\int }_{0}^{t} d τ {T}_{X} ( ( t - τ ) {v}_{o} - {ζ}_{X} ) B ( τ ) {e}^{- \frac{t - τ}{{τ}_{0}}} .$$

The acquisition may be divided in n cycles, and for a given recording cycle define \hat{t}=t−nΔt_{c}−Δtₐ

$${WFL}_{r} ( {v}_{o} , n , \hat{t} > Δ {t}_{a} ) = B {\sum }_{k = 0}^{n} {\int }_{k Δ {t}_{c}}^{k Δ {t}_{c} + Δ {t}_{a}} d {τ}^{′} {e}^{- \frac{\hat{t} + n Δ {t}_{c} + Δ {t}_{a} - {τ}^{′}}{{τ}_{0}}} {T}_{X} ( {v}_{o} ( \hat{t} + n Δ {t}_{c} + Δ {t}_{a} - {τ}^{′} ) - {ζ}_{X} )$$

3 types of WFL are defined for the sake of providing insight into WFL behavior. The constants of these activation/recording frames are listed in

### Table 2.

TABLE 2
Constants of Activation/Recording Frames

| | SLOW | NORMAL | FAST |
|---|---|---|---|
| Δtₐ [s] | 5.967 | 1.1934 | 0.3315 |
| Δtᵣ [s] | 55.029 | 28.9731 | 5.967 |

Keeping track of cycle number is important to understand transient behavior and will be called ghost signals at low velocities. Ghost signals come from a signal originating from a previous cycle reaching the detection time window in each cycle. It is more prone to be visible in fast mode, as between 2 cycles, there is less decay in signal strength.

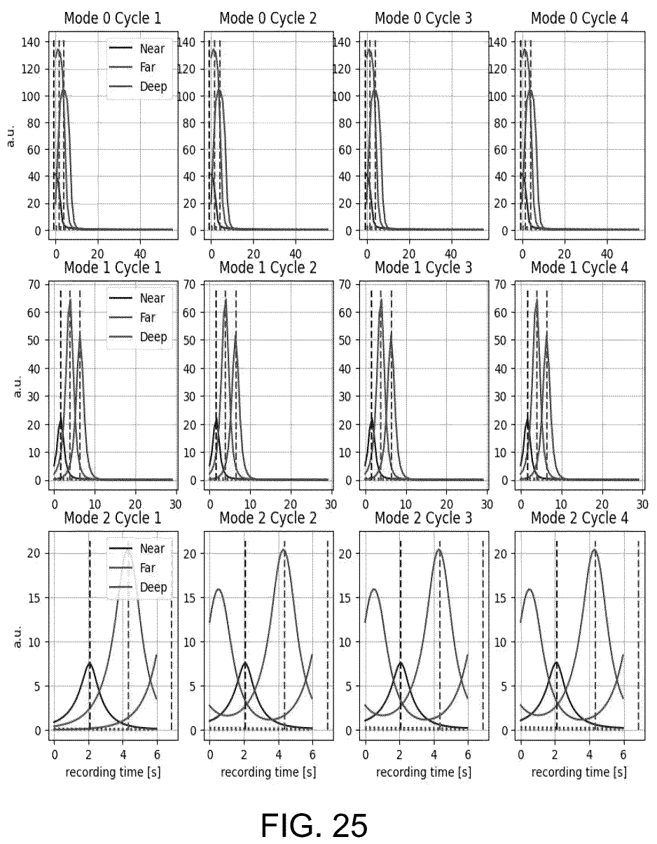

An example of WFL results is shown in FIG. 25. A ghost signal is visible for the fast mode. The dashed vertical lines correspond to expected peak of signal, occurring at

$${t}_{r} ≃ \frac{{ζ}_{X}}{{v}_{o}} = \frac{Δ {t}_{a}}{2} .$$

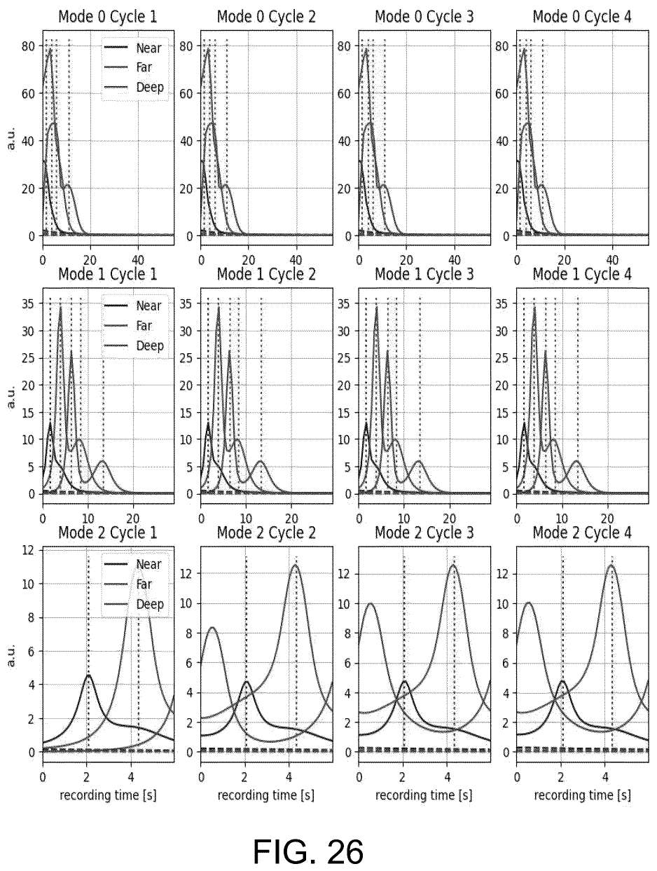

FIG. 26 presents a case a WFL in a completion with tubing and casing, with different water velocities in the tubing and in annulus A. It is observed that the signal amplitude coming from annulus A is, as expected, lower, but still detectable.

Example embodiments of the claims are recited next. The recitation of these embodiments should not be considered limiting. In one example embodiment, a method to predict a three-dimensional distribution of oxygen in a formation is disclosed. The method may comprise lowering a tool into a formation wellbore. The method may further comprise activating the tool inside the formation, wherein the activating sends neutrons to the formation. The method may further comprise using spectroscopy, measuring a signal amplitude originating from the wellbore resulting from the activating of the tool within at least two different detectors along an axis of the wellbore. The method may further comprise determining an axial velocity of activated oxygen, on a wellbore regional basis, from the measuring of the signal amplitude originating from the activating of the tool.

In another example embodiment, the method may be accomplished wherein the tool is a pulsed-neutron-lifetime tool.

In another example embodiment, the method may be accomplished wherein the wellbore is one of a open borehole and a cased wellbore.

In another example embodiment, the method may further comprise determining a flow of a fluid based upon the axial velocity of activated oxygen.

In another example embodiment, the method may be accomplished wherein the activated oxygen is in the form of one of water and carbon dioxide.

In another example embodiment, the method may be accomplished wherein the lowering is at a fixed location or the lowering includes movement during the entire method.

In another example embodiment, a method to develop continuous oxygen activation response curves for a formation is disclosed. The method may comprise lowering a pulsed neutron lifetime tool into a formation wellbore. The method may further comprise activating the pulsed neutron lifetime tool inside the formation, wherein the activating sends neutrons to the formation, The method may further comprise using spectroscopy, measuring a signal amplitude originating from the wellbore resulting from the activating of the tool within at least two different detectors along an axis of the wellbore, The method may further comprise using a model, performing calculations for continuous oxygen activation responses based upon different positions of the tool within the wellbore to obtain model results. The method may further comprise determining an axial velocity of activated oxygen from the measuring of the signal amplitude originating from the activating of the tool based upon a homogenous medium. The method may further comprise comparing the model results to the determined axial velocity of activated oxygen to determine a closest match producing a final continuous oxygen activation curve.

In another example embodiment, the method may be accomplished wherein the activating of the pulsed neutron lifetime tool occurs during one of tool lowering and tool raising.

In another example embodiment, the method may be accomplished wherein the model simulates at least one of static borehole water and moving borehole water velocities.

In another example embodiment, the method may be accomplished wherein the model accounts for types of borehole fluids, a presence of tubing, a presence of casing, differing annulus materials and a variable surrounding formation.

In another example embodiment, the method may be accomplished wherein model results account for tool velocity, oxygen velocity and different layers within the formation.

In another example embodiment, a method to create a water flow log for a formation is disclosed. The method may comprise lowering a tool into a formation wellbore. The method may further comprise activating the tool inside the formation, wherein the activating sends neutrons to the formation. The method may further comprise using spectroscopy, measuring a signal amplitude originating from the wellbore resulting from the activating of the tool within at least two different detectors along an axis of the wellbore. The method may further comprise determining an axial velocity of activated oxygen, on a wellbore regional basis, from the measuring of the signal amplitude originating from the activating of the tool. The method may further comprise correlating the axial velocity of activated oxygen to a flow of water in the formation to produce a water flow log.

In another example embodiment, the method may be accomplished wherein the lowering of the tool in the wellbore, the activating and the measuring are done in multiple repetitions.

In another example embodiment, the method may be accomplished wherein a number of cycle repetitions is tracked.

In another example embodiment, the method may be accomplished wherein transient behavior is measured during the method.

In another example embodiment, the method may be accomplished wherein a time is recorded during measuring of the signal amplitude.

In another example embodiment, the method may be accomplished wherein the correlating of the axial velocity is based upon the measuring of the signal amplitude in at least one of a greater than 1 second interval, an approximately 1 second interval and a less than one second interval.

In another example embodiment, the method may be accomplished wherein the model accounts for types of borehole fluids, a presence of tubing, a presence of casing, differing annulus materials and a variable surrounding formation.

In another example embodiment, the method may be accomplished wherein model results account for tool velocity, oxygen velocity and different layers within the formation.

In another example embodiment, the method may be accomplished wherein the water flow log is at least one of displayed and saved in a non-volatile memory.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may be varied in many ways. Such variations are not to be regarded as a departure from the disclosure, and all such modifications are intended to be included within the scope of the disclosure.

While embodiments have been described herein, those skilled in the art, having benefit of this disclosure, will appreciate that other embodiments are envisioned that do not depart from the inventive scope. Accordingly, the scope of the present claims or any subsequent claims shall not be unduly limited by the description of the embodiments described herein.

What is claimed is:

1. A method to predict a three-dimensional distribution of oxygen in a formation, comprising:
lowering a tool into a formation wellbore;
activating the tool inside the formation, wherein the activating sends neutrons to the formation;
using spectroscopy, measuring a signal amplitude originating from the wellbore resulting from the activating of the tool within at least two different detectors along an axis of the wellbore; and
determining an axial velocity of activated oxygen, on a wellbore regional basis, from the measuring of the signal amplitude originating from the activating of the tool.

2. The method according to claim 1, wherein the tool is a pulsed-neutron-lifetime tool.

3. The method according to claim 1, wherein the wellbore is one of a open borehole and a cased wellbore.

4. The method according to claim 1, further comprising determining a flow of a fluid based upon the axial velocity of activated oxygen.

5. The method according to claim 4, wherein the activated oxygen is in the form of one of water and carbon dioxide.

6. The method according to claim 1, wherein the lowering is at a fixed location or the lowering includes movement during the entire method.

7. A method to develop continuous oxygen activation response curves for a formation, comprising:
lowering a pulsed neutron lifetime tool into a formation wellbore;
activating the pulsed neutron lifetime tool inside the formation, wherein the activating sends neutrons to the formation;
using spectroscopy, measuring a signal amplitude originating from the wellbore resulting from the activating of the tool within at least two different detectors along an axis of the wellbore;
using a model, performing calculations for continuous oxygen activation responses based upon different positions of the tool within the wellbore to obtain model results;
determining an axial velocity of activated oxygen from the measuring of the signal amplitude originating from the activating of the tool based upon a homogenous medium; and
comparing the model results to the determined axial velocity of activated oxygen to determine a closest match producing a final continuous oxygen activation curve.

8. The method according to claim 7, wherein the activating of the pulsed neutron lifetime tool occurs during one of tool lowering and tool raising.

9. The method according to claim 7, wherein the model simulates at least one of static borehole water and moving borehole water velocities.

10. The method according to claim 7, wherein the model accounts for types of borehole fluids, a presence of tubing, a presence of casing, differing annulus materials and a variable surrounding formation.

11. The method according to claim 7, wherein model results account for tool velocity, oxygen velocity and different layers within the formation.

12. A method to create a water flow log for a formation, comprising:
lowering a tool into a formation wellbore;
activating the tool inside the formation, wherein the activating sends neutrons to the formation;
using spectroscopy, measuring a signal amplitude originating from the wellbore resulting from the activating of the tool within at least two different detectors along an axis of the wellbore;
determining an axial velocity of activated oxygen, on a wellbore regional basis, from the measuring of the signal amplitude originating from the activating of the tool; and
correlating the axial velocity of activated oxygen to a flow of water in the formation to produce a water flow log.

13. The method according to claim 12, wherein the lowering of the tool in the wellbore, the activating and the measuring are done in multiple repetitions.

14. The method according to claim 13, wherein a number of cycle repetitions is tracked.

15. The method according to claim 14, wherein transient behavior is measured during the method.

16. The method according to claim 12, wherein a time is recorded during measuring of the signal amplitude.

17. The method according to claim 12, wherein the correlating of the axial velocity is based upon the measuring of the signal amplitude in at least one of a greater than 1 second interval, an approximately 1 second interval and a less than one second interval.

18. The method according to claim 12, wherein the model accounts for types of borehole fluids, a presence of tubing, a presence of casing, differing annulus materials and a variable surrounding formation.

19. The method according to claim 12, wherein model results account for tool velocity, oxygen velocity and different layers within the formation.

20. The method according to claim 12, wherein the water flow log is at least one of displayed and saved in a non-volatile memory.
